(19) United States
(12) Patent Application Publication
(10) Pub. No.: US 2004/0252433 A1
(43) Pub. Date: Dec. 16, 2004

(54) Resetable over-current protection device and method of making the same

(75) Inventors: Wen-Lung Liu, Taipei (TW); Chi-Hao Chiu, Taipei (TW); Kang-Neng Hsu, Hsinchu Hsien (TW); Szu-Lung Sun, Hsinchu (TW)

Correspondence Address: Ladas & Parry, 26 West 61st Street, New York, NY, 10023, US

(73) Assignee: INPAQ TECHNOLOGY CO., LTD.

(21) Appl. No.: 10/853,617

(22) Filed: May 25, 2004

(30) Foreign Application Priority Data
Jun. 10, 2003 (TW) 092115677

(51) Int. Cl. H02H 3/08

(52) U.S. Cl. 361/93.1

(57) ABSTRACT

The present invention relates to a resetable over-current protection device. The device is characterized in that: disconnected areas are maintained at end faces of formed cutting regions of the protection device, wherein one or two of the end faces of the formed cutting regions are partly formed with electrically conductive layers so as to increase the lifespan of the device and allows easy manufacturing of the device. The present invention also provides a method of manufacturing the resetable over-current protection device. The method is characterized in that a polymer-based sheet is divided into a plurality of components from which resetable over-current protection devices are subsequently manufactured into the resetable over-current protection devices to save the cost of material.

### CROSS-REFERENCES TO RELATED APPLICATIONS

Not Applicable

### STATEMENT REGARDING FEDERALLY SPONSORED RESEARCH OR DEVELOPMENT

Not Applicable

### FIELD OF INVENTION

The present invention relates to a resetable over-current protection device, particularly one where disconnected areas are maintained at end faces of formed cutting regions of the protection device, wherein the end faces of the formed cutting regions are partly formed with electrically conductive layers so as to increase the lifespan of the device, to enhance flexibility in manufacturing and to reduce consumption of materials.

### BACKGROUND OF INVENTION

Resetable over-current protection devices are characterized by their capability to automatically reset to their original state of low resistance after current switching-off caused by over-current actuations. In other words, the devices may be actuated or operated repetitively. Such devices have been widely implemented in circuits for various kinds of electronic products.

A resetable over-current protection device is mainly composed of polymer materials that expand upon heating to serve as means for switching off currents. The thermal expansion coefficients of polymer materials are far greater than those of metal materials for forming conventional electrodes. The repetitive actuations of a resetable over-current protection device will result in stress to be accumulated at the electrode connection structure of the resetable over-current protection device, which would greatly affect the lifespan of the resetable over-current protection device. To meet the design demands, many electrode connection structures have been implemented in the currently available resetable over-current protection devices made by corresponding manufacturing processes that accommodate the electrode structures.

In view of the problems found in electrode connection structure of commercially available resetable over-current protection devices, the present invention discloses an electrode connection structure of resetable over-current protection device, as a solution that provides maximum actuation cycles within the lifespan of the resetable over-current protection device and that allows easy manufacturing and reduces and consumption of material.

FIGS. 1A-1C illustrate the first example for a conventional resetable over-current protection device. The device adopts the common through-hole process for making a PCB to form a plurality of through holes 10 in each of the neighboring components 4ab on a device sheet 1. A first and a second electrode connections 12, 13 are then formed at each of the through holes 10, for connecting a top and a bottom laminar electrodes 11a and 11b of the protection device, respectively, as shown in FIGS. 1B and 1C. The primary device sheet 1 is then divided into a plurality of final device components 4ab along the incision lines 14x, 14y formed on the sheet exterior, as shown in FIG. 1B.

In such prior art, the proportion of wasted material is kept to minimal because all components 4ab on the primary device sheet 1 neighbor each other. After fabrication, other than the relative small regions of the through holes 10, sides 14z of polymer material 6 are not surrounded by the top and bottom laminar electrodes 11a, 11b nor the second electrode connections 13. As such, a sufficient space is provided for the enclosed polymer to release stress upon thermal expansion. Such through-hole type electrodes can generally meet the required cycles of repetitive actuations within the lifespan of resetable over-current protection devices unless they have been subjected to damages in subsequent manufacturing processes, since stringent requirements for structural strength are not applied thereto. The problems encountered by such prior art reside in the difficulty of preventing from damaging the electrode connections 12, 13 prior to formation of the final over-current protection devices.

As shown in FIGS. 1A and 1B, there are less restrictions in cutting along the incision lines 14y extending along the Y-axis because the incision lines 14y do not pass through the first and second electrode connections 12, 13, such that many cutting mechanisms may be adopted, such as a punching die, a cutting tool or a rotary tool, to perform the cutting operation. However, there are more restrictions in cutting along the incisions lines 14x extending along the X-axis in FIG. 1B because the incision lines 14x pass through the first and second electrode connections 12, 13, such that the punching die or cutting tool may cause damages to the first and second electrode connections having smaller dimensions due to mechanical stress, thereby reducing strength of the first and second electrode connections and affecting the maximum cycles of repetitive actuations within the lifespan of the resetable over-current protection devices. Hence, a diamond cutting apparatus in the form of rotary tool becomes the only choice in making the resetable over-current protection devices. Such a process not only involves the problem of poor operability, but also significant consumption of pure water. To summarize the problems of cutting along the X and Y-axes, if different processes are used to cut along the incision lines 14x and 14y, the fabrication line needs to be designed to accommodate the different processes; if, on the other hand, the same process is used along the incision lines 14x and 14y, the diamond cutting apparatus is the only choice to be used in the fabrication line, which results in much higher consumption of pure water.

FIGS. 2A-2D illustrate the electrode connection structure in the second example for a conventional resetable over-current protection device. The device adopts the common die punching process to form a plurality of through slots 20 in a primary device sheet 2, as shown in FIG. 2A, wherein the primary device sheet 2 is then divided into a plurality of strips. The through-hole process commonly adopted in PCB fabrication is then adopted to form left electrode connections 22a, 23a and right electrode connections 22b, 23b for connecting a top laminar electrode 21a and a bottom laminar electrode 21b on individual pieces of strips, as shown in FIGS. 2B to 2D. The top laminar electrode 21a and the bottom laminar electrode 21b are, respectively, formed thereover with a top insulation layer 22c and a bottom insulation layer 22d. The primary device sheet 2 is then divided into a plurality of final device components 5ab along the incision lines 24y formed on the exteriors of the strips, as shown in FIG. 2B. FIG. 2B illustrates one of the final device components 5ab. Portions of the device component 5ab in FIG. 2B, that are proximate to the left and right end faces 25a, 25b, are completely enclosed by the left electrode connections 23a and the right electrode connections 23b, as shown in FIG. 2C. The left electrode connections 22a and right electrode connections 22b jointly form a first pair of substantially symmetrical electrodes 22, while the left electrode connections 23a and the right electrode connections jointly form a second pair of substantially symmetrical electrodes 23.

The complete enclosed structure at the end faces 25a, 25b that must be connected, in the electrode structures in the second example of prior art, provides an enhanced connection as compared to the first example of prior art. In addition, the enlarged connection area allows the use of the punching dies or cutting tools that have improved operability and lower resource consumption, to perform cutting operation along the incision lines 24y extending along the Y-axis in FIG. 2B during formation of the final over-current protection devices. However, problems are still found in such prior art, including:

1. The wasted materials that have been removed by the punching die to form the through slots on the primary device sheet 2 result in a relatively low quantity of device components within a fixed area of primary device sheet.

2. The space for the polymer to release stress upon thermal expansion is reduced by the complete enclosure of the polymer by the electrode connections (22a, 22b, 23a, 23b), such that requirements for structural strength of such through-slot electrodes must be more stringent as compared to those for the first example of prior art.

3. During formation of the final over-current protection devices 5ab by cutting along the incision lines 24y extending along the Y-axis, use of the punching dies or cutting tools may still cause damages to end faces of the electrode structures, unless the electrode structures or the electrode layers are of a sufficient thickness.

4. During formation of the final over-current protection devices 5ab by cutting along the incision lines 24y extending along the Y-axis, use of the diamond cutting apparatus will need to face the problem of poor operability and consumption of pure water in exchange for lowering strength requirements for the electrode structures.

### SUMMARY OF INVENTION

In view of the problems found in the conventional electrode connection structures of resetable over-current protection devices, the present invention discloses an electrode connection structure of resetable over-current protection device, as a solution that provides maximum actuation cycles within the lifespan of the resetable over-current protection device and that allows easy manufacturing and reduces and consumption of material.

It is a primary objective of this invention is to fully utilize a primary sheet in the first step of manufacturing the electrode connection structure of resetable over-current protection device of the present invention.

It is a further objective of this invention to provide an electrode connection structure of resetable over-current protection device, wherein the electrode connection structure only occupies a small portion of area at end faces of each component to keep a maximum space for thermal expansion of the polymer material, so as to lower the strength requirements for the electrode connection structure.

It is another objective of this invention to provide an electrode connection structure of resetable over-current protection device, where the locations of cutting operations are designed to dodge away from end faces formed by the incision lines, so as to allow easy operation, to reduce resource consumption, and to ensure that subsequent manufacturing processes do not cause damages to the electrode connection structure.

To achieve the above objectives, according to the first aspect of a resetable over-current protection device of the present invention, the resetable over-current protection device includes:

a resistance variable material, having: a top surface, a bottom surface, a left end face, and a right end face;

a top laminar electrode disposed above the top surface, the top laminar electrode having a top trench for exposing a part of the material;

a bottom laminar electrode disposed above the bottom surface; a top insulation layer covering a part of the top laminar electrode and the top trench;

a bottom insulation layer covering a part of the bottom laminar electrode;

a first left connection layer, covering a part of the left end face of the material, and the top laminar electrode and bottom laminar electrode proximate to the left end face, for electrically connecting the top laminar electrode and the bottom laminar electrode;

a first right connection, covering the top laminar electrode proximate to the right end face;

a second left connection layer, covering the first left connection layer to serve as a first contact point; and

a second right connection, covering the first right connection to serve as a second contact point, wherein the first left connection layer preferably covers 15 to 95% of an entire area of the left end face of the material, better preferably 30 to 80%, and best preferably 35 to 50%.

According to the second aspect of a resetable over-current protection device of the present invention, the resetable over-current protection device includes:

a resistance variable material, having: a top surface, a bottom surface, a left end face and a right end face;

a top laminar electrode disposed above the top surface, the top laminar electrode having a top trench for exposing a part of the material;

a bottom laminar electrode disposed above the bottom surface, the bottom laminar electrode having a bottom trench for exposing a part of the material;

a top insulation layer covering a part of the top laminar electrode and the top trench;

a bottom insulation layer covering a part of the bottom laminar electrode and the bottom trench;

a first left connection layer, covering a part of the left end face of the material, and the top laminar electrode and bottom laminar electrode proximate to the left end face, for electrically connecting the top laminar electrode and the bottom laminar electrode;

a first right connection, covering a part of the right end face of the material, and the top laminar electrode and bottom laminar electrode proximate to the right end face, for electrically connecting the top laminar electrode and the bottom laminar electrode;

a second left connection layer, covering the first left connection layer to serve as a first contact point; and

a second right connection, covering the first right connection to serve as a second contact point, wherein the first left connection layer preferably covers 15 to 95% of an entire area of the left end face of the material, better preferably 30 to 80%, and best preferably 35 to 50%; and wherein the first right connection layer preferably covers 15 to 95% of an entire area of the right end face of the material, better preferably 30 to 80%, and best preferably 35 to 50%.

According to the third aspect of a resetable over-current protection device of the present invention, the resetable over-current protection device includes:

a resistance variable material, having: a top surface, a bottom surface, a left end face, and a right end face;

a top laminar electrode disposed above the top surface, the top laminar electrode having a top trench for exposing a part of the material;

a bottom laminar electrode disposed above the bottom surface; a top insulation layer covering a part of the top laminar electrode and the top trench;

a bottom insulation layer covering a part of the bottom laminar electrode;

a first left connection layer, covering the top laminar electrode and the bottom laminar electrode proximate to the left end face, and the material proximate to the left end face and the right end face, for electrically connecting the top laminar electrode and the bottom laminar electrode;

a first right connection, covering the top laminar electrode proximate to the right end face;

a second left connection layer, covering the first left connection layer to serve as a first contact point; and

a second right connection, covering the first right connection to serve as a second contact point.

According to the fourth aspect of a resetable over-current protection device of the present invention, the resetable over-current protection device includes:

a resistance variable material, having: a top surface, a bottom surface, a left end face, and a right end face;

a top laminar electrode disposed above the top surface, the top laminar electrode having a top trench for exposing a part of the material;

a bottom laminar electrode disposed above the bottom surface, the bottom laminar electrode having a bottom trench for exposing a part of the material;

a top insulation layer covering a part of the top laminar electrode and the top trench;

a bottom insulation layer covering a part of the bottom laminar electrode and the bottom trench;

a first left connection layer, covering the top laminar electrode and the bottom laminar electrode proximate to the left end face, and the material proximate to the left end face and the right end face, for electrically connecting the top laminar electrode and the bottom laminar electrode;

a first right connection layer, covering the top laminar electrode and the bottom laminar electrode proximate to the right end face, and the material proximate to the left end face and the right end face, for electrically connecting the top laminar electrode and the bottom laminar electrode;

a second left connection layer, covering the first left connection layer to serve as a first contact point; and

a second right connection, covering the first right connection to serve as a second contact point.

It is yet another objective of the present invention to provide a method for manufacturing resetable over-current protection devices to fully utilize the primary sheet.

To achieve the above objective, according to the first aspect of a method for manufacturing resetable over-current protection devices of the present invention, the method includes the steps of:

(a) providing a resistance variable sheet having a top laminar electrode and a bottom laminar electrode;

(b) cutting the sheet into a plurality of strips, each strip having: a top surface, a bottom surface, a left end face and a right end face;

(c) removing a part of the top laminar electrode of each of the strips along a longitudinal direction of the sheet to form a top trench, for exposing a part of the sheet;

(d) covering a part of the top laminar electrode and the top trench with a top insulation layer;

(e) covering a part of the bottom laminar electrode with a bottom insulation layer;

(f) covering each of the top laminar electrode and the bottom laminar electrode proximate to the left end face, and a part of the left end of each of the strips with first left connection layers, for electrically connecting the top laminar electrode and the bottom laminar electrode;

(g) covering the top laminar electrode proximate to the right end face with a first right connection;

(h) covering each of the first left connection layers with second left connection layers serving as a first contact point;

(i) covering the first right connection with a second right connection serving as a second contact point; and

(j) cutting each of the strips to form a plurality of resetable over-current protection devices.

To achieve the above objective, according to the second aspect of a method for manufacturing resetable over-current protection devices of the present invention, the method includes the steps of:

(a) providing a resistance variable sheet having a top laminar electrode and a bottom laminar electrode;

(b) cutting the sheet into a plurality of strips, each strip having: a top surface, a bottom surface, a left end face and a right end face;

(c) removing a part of the top laminar electrode of each of the strips along a longitudinal direction of the sheet to form a top trench, for exposing a part of the sheet;

(d) removing a part of the bottom laminar electrode of each of the strips along a longitudinal direction of the sheet to form a bottom trench, for exposing a part of the sheet;

(e) covering a part of the top laminar electrode and the top trench with a top insulation layer;

(f) covering a part of the bottom laminar electrode with a bottom insulation layer and the bottom trench;

(g) covering each of the top laminar electrode and the bottom laminar electrode proximate to the left end face, and a part of the left end of each of the strips with first left connection layers, for electrically connecting the top laminar electrode and the bottom laminar electrode;

(h) covering each of the top laminar electrode and the bottom laminar electrode proximate to the right end face, and a part of the right end of each of the strips with first right connection layers, for electrically connecting the top laminar electrode and the bottom laminar electrode;

(i) covering each of the first left connection layers with second left connection layers serving as a first contact point;

(j) covering each of the first right connections with second right connections serving as a second contact point; and

(k) cutting each of the strips to form a plurality of resetable over-current protection devices.

To achieve the above objective, according to the third aspect of a method for manufacturing resetable over-current protection devices of the present invention, the method includes the steps of:

(a) providing a resistance variable sheet having a top laminar electrode and a bottom laminar electrode;

(b) cutting the sheet into a plurality of strips, each strip having: a top surface, a bottom surface, a left end face and a right end face;

(c) removing a part of the top laminar electrode of each of the strips along a transverse direction of the sheet to form a plurality of top trenches, for exposing a part of the sheet;

(d) covering a part of the top laminar electrode and the top trench with a top insulation layer;

(e) covering a part of the bottom laminar electrode with a bottom insulation layer;

(f) covering each of the top laminar electrode, the bottom laminar electrode, the left end face and the right end face with first left connection layers to form a plurality of looped connection layers, for electrically connecting the top laminar electrode and the bottom laminar electrode;

(g) covering each of the first left connection layers with second left connection layers serving as a contact point; and

h) cutting each of the strips to form a plurality of resetable over-current protection devices.

To achieve the above objective, according to the fourth aspect of a method for manufacturing resetable over-current protection devices of the present invention, the method includes the steps of:

(a) providing a resistance variable sheet having a top laminar electrode and a bottom laminar electrode;

(b) cutting the sheet into a plurality of strips, each strip having: a top surface, a bottom surface, a left end face and a right end face;

(c) removing a part of the top laminar electrode of each of the strips along a transverse direction of the sheet to form a plurality of top trenches, for exposing a part of the sheet;

(d) removing a part of the bottom laminar electrode of each of the strips along a transverse direction of the sheet to form a plurality of bottom trenches, for exposing a part of the sheet;

(e) covering a part of the top laminar electrode and the top trench with a top insulation layer;

(f) covering a part of the bottom laminar electrode with a bottom insulation layer and the bottom trenches;

(g) covering each of the top laminar electrode, the bottom laminar electrode, the left end face and the right end face with first left connection layers to form a plurality of looped connection layers, for electrically connecting the top laminar electrode and the bottom laminar electrode;

(h) covering each of the top laminar electrode, the bottom laminar electrode, the left end face and the right end face of each of the strips with first right connection layers, whereby each of the first right connections electrically connects the top laminar electrode and the bottom laminar electrode;

(i) covering each of the first left connection layers with second left connection layers serving as a first contact point;

(j) covering each of the first right connections with second right connections serving as a second contact point; and

(k) cutting each of the strips to form a plurality of resetable over-current protection devices.

These and other modifications and advantages will become even more apparent from the following detained description of a preferred embodiment of the invention and from the drawings in which:

### BRIEF DESCRIPTION OF THE DRAWINGS

FIGS. 1A-1C are schematic views illustrating the first example for a conventional resetable over-current protection device containing an electrode connection fabricated from circular through-holes, wherein FIG. 1B is an enlarged plan view of a device containing a circular through hole within FIG. 1A and FIG. 1C is a cross-sectional view showing a cross-sectional view of the device in FIG. 1B;

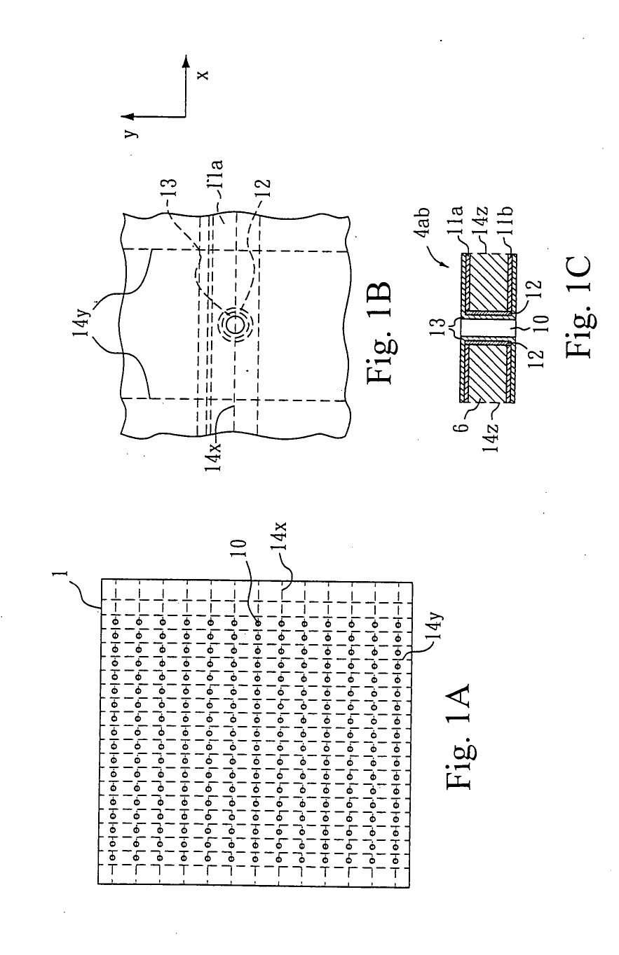

FIGS. 2A-2D are schematic views illustrating the second example for a conventional resetable over-current protection device an electrode connection fabricated from through-slots.

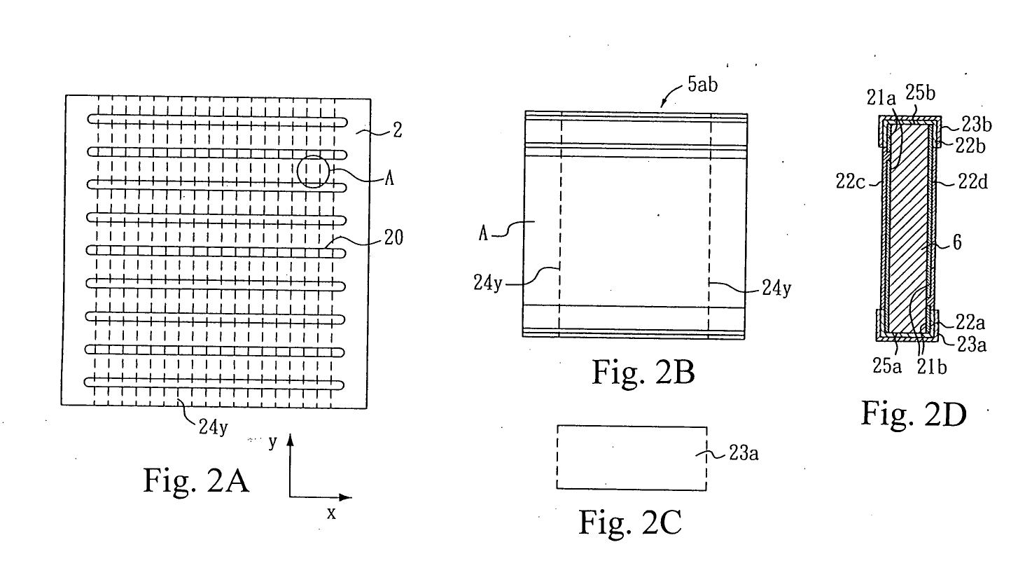

FIGS. 3A-3E are schematic views illustrating the electrode connection structure of resetable over-current protection device according to a first embodiment of the present invention.

FIGS. 4A-4E are schematic views illustrating the electrode connection structure of resetable over-current protection device according to a further embodiment of the present invention.

FIGS. 5A-5E are schematic views illustrating a first method of manufacturing the various components constructing the electrode connection structure of resetable over-current protection device in FIGS. 3A-3E.

FIGS. 6A-6E are schematic views illustrating a second method of manufacturing the various components constructing the electrode connection structure of resetable over-current protection device in FIGS. 3A-3E.

FIGS. 7A-7E are schematic views illustrating a first method of manufacturing the various components constructing the electrode connection structure of resetable over-current protection device in FIGS. 4A-4E.

FIGS. 8A-8E are schematic views illustrating a second method of manufacturing the various components constructing the electrode connection structure of resetable over-current protection device in FIGS. 4A-4E.

### DETAILED DESCRIPTION OF THE INVENTION (PREFERRED EMBODIMENTS)

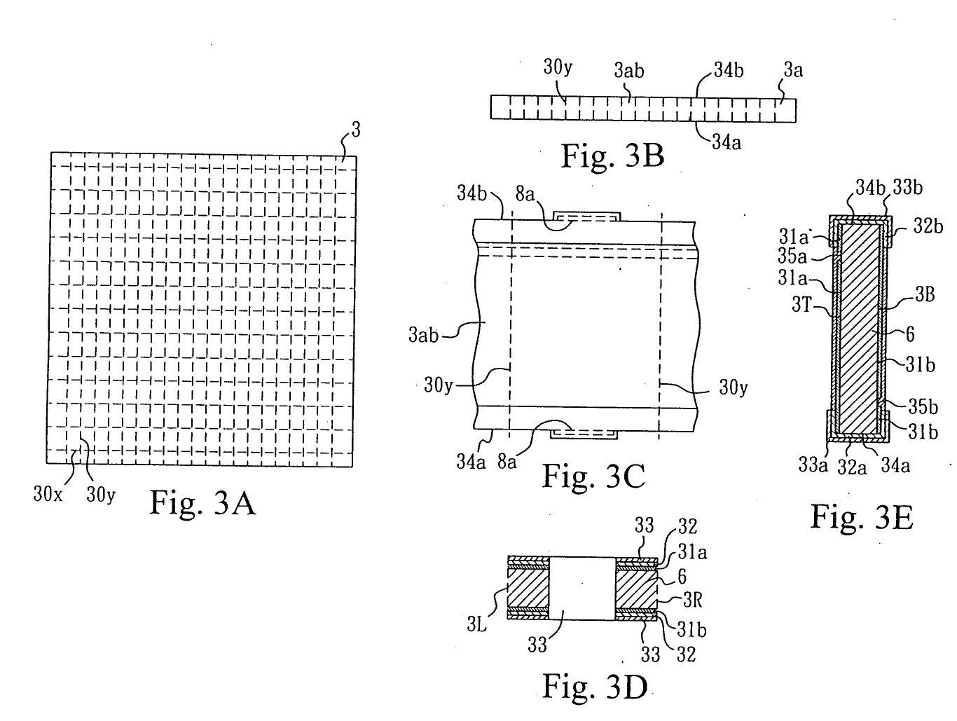

The present invention discloses an electrode connection structure of resetable over-current protection device and method of making the same, as those illustrated in FIGS. 3A-3E to 8A-8E.

FIGS. 3A-3E illustrate the electrode connection structure of resetable over-current protection device according to a first embodiment of the present invention. A primary device sheet 3 in FIG. 3A is first punched or cut into a plurality of strips 3a, as shown in FIG. 3B, along the incision lines 30x formed on the sheet exterior and extending along the X-axis. The strips are then divided into a plurality of device components 3ab along the incision lines 30y formed on the sheet exterior and extending along the Y-axis. Each of the components 3ab exhibits a cubic configuration, including a top surface 3T, a bottom surface 3B, a left surface 3L, a right side surface 3R, a left end face 34b and a right end face 34b. As shown in FIGS. 3C-3E, the two end faces 34a, 34b and two central regions 8a of each of the device components 34b are, respectively, formed thereon with a first pair of connection layers 32 and a second pair of connection layers 33 for connecting a top and a bottom laminar electrode 31a and 32b of the resetable over-current protection devices. The first pair of connection layers 32 is dimensioned to cover 15 to 95% of an entire area of the two end faces 34a, 34b of each of the device components 3ab, better preferably 30 to 80%, and best preferably 35 to 50%. As shown in FIG. 3E, the top and bottom laminar electrode 31a, 31b each include a top trench 35a and a bottom trench 35b. Though FIG. 3D illustrates one pair of first connection layers 32 and one pair of second connection layers 33, the left end face 34a and right end face 34b of each strip 3a are formed thereon with a plurality of equally-spaced first pairs of connection layers 32 and second pairs of connection layers 33. The first pairs of connection layers 32 each include a first left connection layer 32a and a first right connection 32b. The first left connection layer 32a electrically connects the top and bottom laminar electrodes 31a and 31b. The second pairs of connection layers 33 each include a second left connection layer 33a and a second right connection 33b. The second left connection layer 33a serves as a contact point to be connected to other electrical devices. The second right connection 33b also serves as a contact point to be connected to other electrical devices. Because the connection layers 32, 33 are designed to dodge away from end faces formed by the incision lines 30y, the strips 3a having the above-mentioned electrode connection structure may be directly punched or cut into a plurality of device components 3ab along the incision lines 30y without damaging connection layers.

According to a second embodiment of the resetable over-current protection device of the present invention, symmetrical connection layers 32, 33 are not required in a final resetable over-current protection device. In other words, the first right connection 32b does not necessarily cover the right end face 34b or the bottom laminar electrode 31b, but only the top laminar electrode 31a, while the second right connection 33b only covers first right connection 32b. In addition, the bottom laminar electrode 31b is not necessarily formed with a bottom trench 35b.

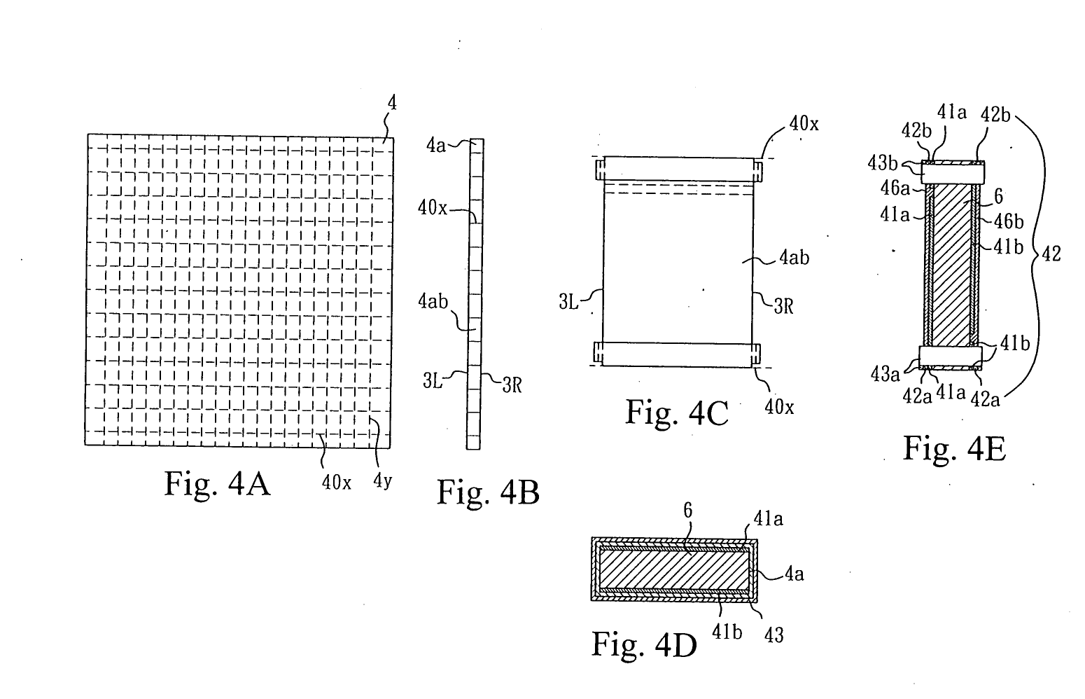

FIGS. 4A-4E illustrate the electrode connection structure of resetable over-current protection device according to a third embodiment of the present invention. A primary device sheet 4 in FIG. 4A is first punched or cut into a plurality of strips 4a, as shown in FIG. 4B, along the incision lines 40y formed on the sheet exterior and extending along the Y-axis (longitudinal direction). The strips are then divided into a plurality of device components 4ab along the incision lines 40x formed on the sheet exterior and extending along the X-axis (traverse direction). As shown in FIGS. 4C-4E, the top surface 3T and bottom surface 3B of each of the device components 4ab are, respectively, formed thereon with a top laminar electrode 41a and a bottom laminar electrode 41b for connecting the resetable over-current protection device. A first pair and a second pair of connection layers 42, 43 are in turn formed on the top and bottom surfaces 3T, 3B and the two side surfaces 3L, 3R proximate to the right and left end faces. The first pair of connection layers 42 includes a first left connection layer 42a and a first right connection 42b. The second pair of connection layers 43 includes a second left connection layer 43a and a second right connection 43b. Because the first pair of connection layers 42 and the second pair of connection layers 43 are designed to dodge away from end faces formed by the incision lines 40x, the strips 4a having the above-mentioned electrode connection structure may be directly punched or cut into a plurality of device components 4ab along the incision lines without damaging electrode connection structures.

According to a fourth embodiment of the resetable over-current protection device of the present invention, symmetrical connection layers 42, 43 are not required in a final resetable over-current protection device. In other words, the first right connection 42b only cover the top laminar electrode 41a, while the second right connection 43b only covers first right connection 42b. In addition, the bottom laminar electrode 41b is not necessarily formed with a bottom trench 45b.

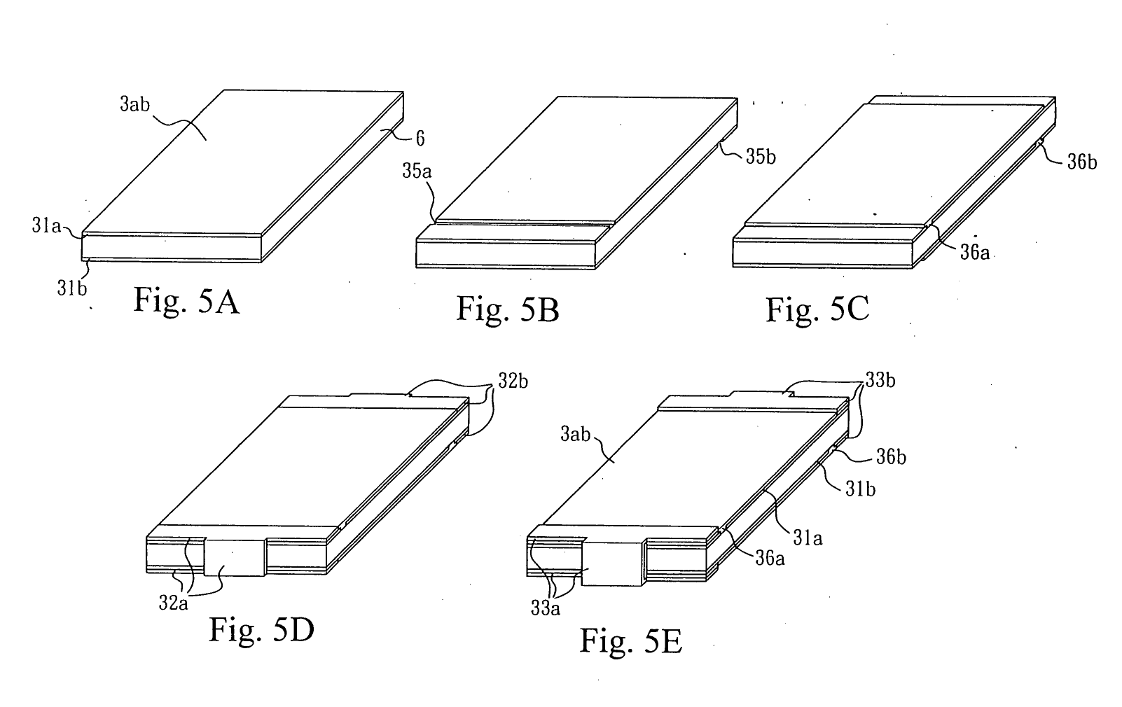

FIGS. 5A-5E illustrate a first method of manufacturing the electrode connection structure of resetable over-current protection device shown in FIGS. 3A-3E. FIG. 5A illustrates a device component 3ab having a top laminar electrode 31a and a bottom laminar electrode 31b, that is divided from a sheet 3.

FIG. 5B illustrates that the top laminar electrode 31a is formed thereon with a top trench 35a, and that the bottom laminar electrode 31b is formed thereon with a bottom trench 35b. FIG. 5C illustrates formation of a top insulation layer 36a and a bottom insulation layer 36b. FIG. 5D illustrates formation of a first left connection layer 32a and a first right connection 32b over a part of each of the left end face 34a and right end face 34b, and above the top lammar electrode 31a and bottom laminar electrode 31b proximate to the end faces. FIG. 5E illustrates formation of a second left connection layer 33a and a second right connection 33b over each of the first left connection layer 32a and first right connection 32b.

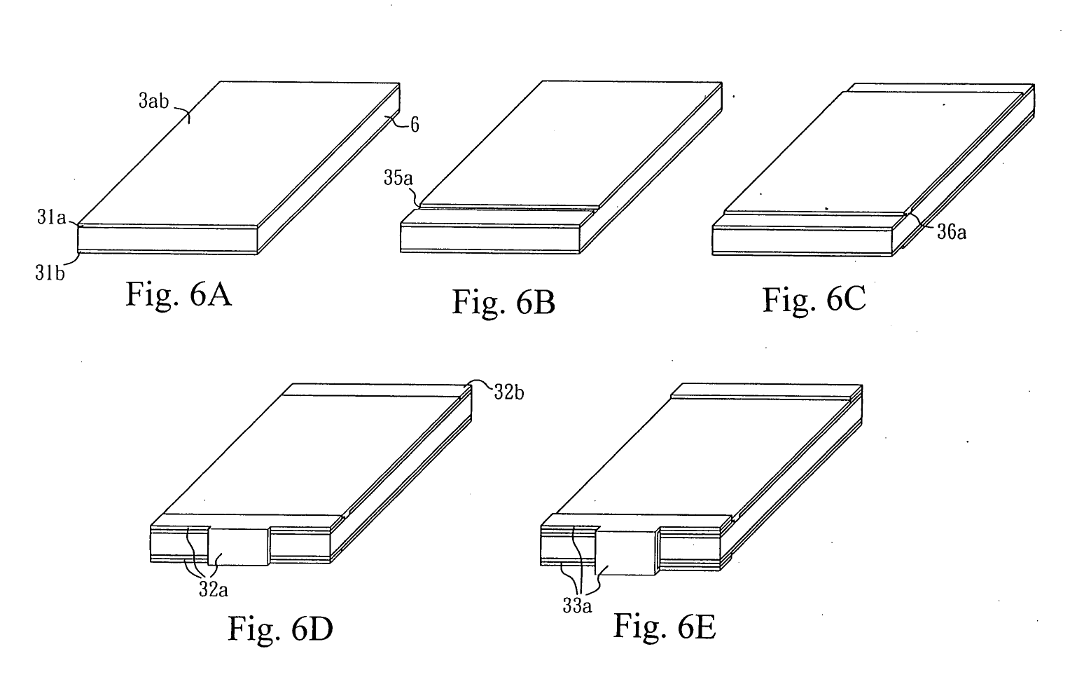

FIGS. 6A-6E illustrate a second method of manufacturing the electrode connection structure of resetable over-current protection device shown in FIGS. 3A-3E. Differing from the device component 3ab of FIGS. 5A-5E where the connection layers 32, 33 are provided at the two end faces 34a, 34b, the device component 3ab in FIGS. 6A-6E is provided with connection layers 32a, 32b at one end face 34a, and the bottom laminar electrode 31b is not formed with a bottom trench 35b. The remaining structures are the same as the embodiment illustrated in FIGS. 5A-5E and not repeated herein.

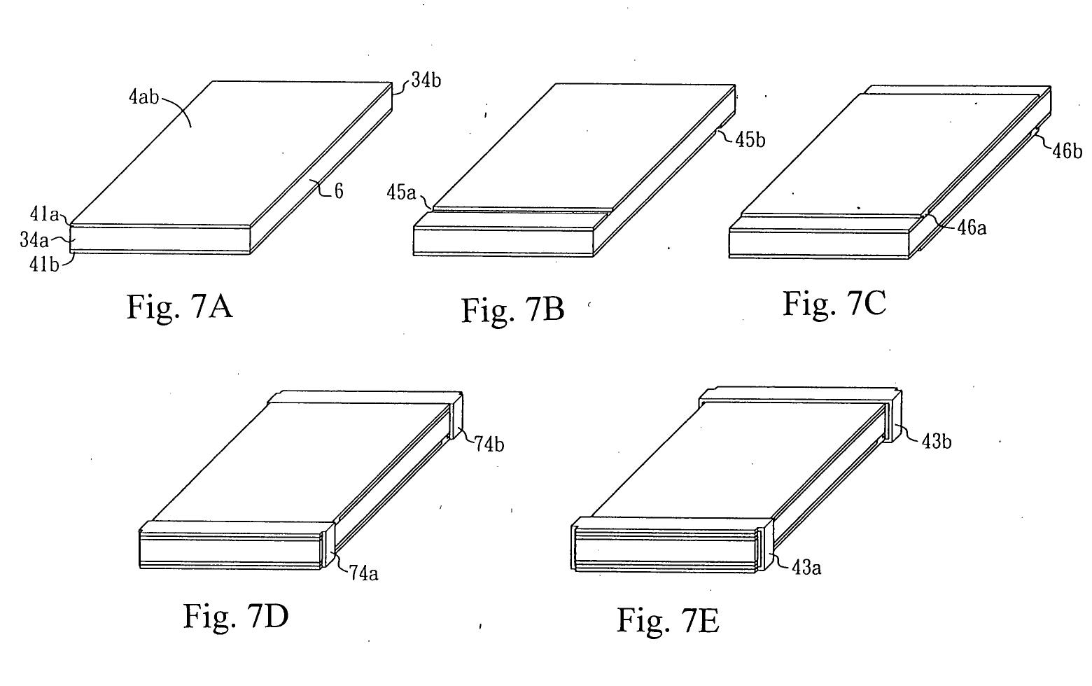

FIGS. 7A-7E illustrate a first method of manufacturing the electrode connection structure of resetable over-current protection device shown in FIGS. 4A-4E. FIG. 7A illustrates a device component 4ab that is divided from a sheet 4, wherein the device component 4a is covered with a top laminar electrode 41a and a bottom laminar electrode 41b. With reference to FIG. 7B, the top laminar electrode 41a is formed therein with a top trench 45a, and the bottom laminar electrode 41b is formed therein with a bottom trench 45b. As shown in FIG. 7C, the top laminar electrode 41a is formed thereover with a top insulation layer 46a, and the bottom laminar electrode 41b is formed thereover with a bottom insulation layer 46b. The top insulation layer 46a passes through the top trench 45a to contact the polymer material 6 disposed between the laminar electrodes 41a and 41b. The top insulation layer 46a and bottom insulation layer 46b do not cover top laminar electrode 41a [symbol] bottom laminar electrode 41b proximate to the end faces 34a, 34b of the component 4ab. As shown in FIG. 7D, the component 4ab proximate to the end faces 34a, 34b components 4ab is covered by a looped first left connection layer 74a and a looped first right connection 74b. As shown in FIG. 7E, the first left connection layer 74a and first right connection 74b are, respectively, covered by a second left connection layer 43a and a second right connection 43b.

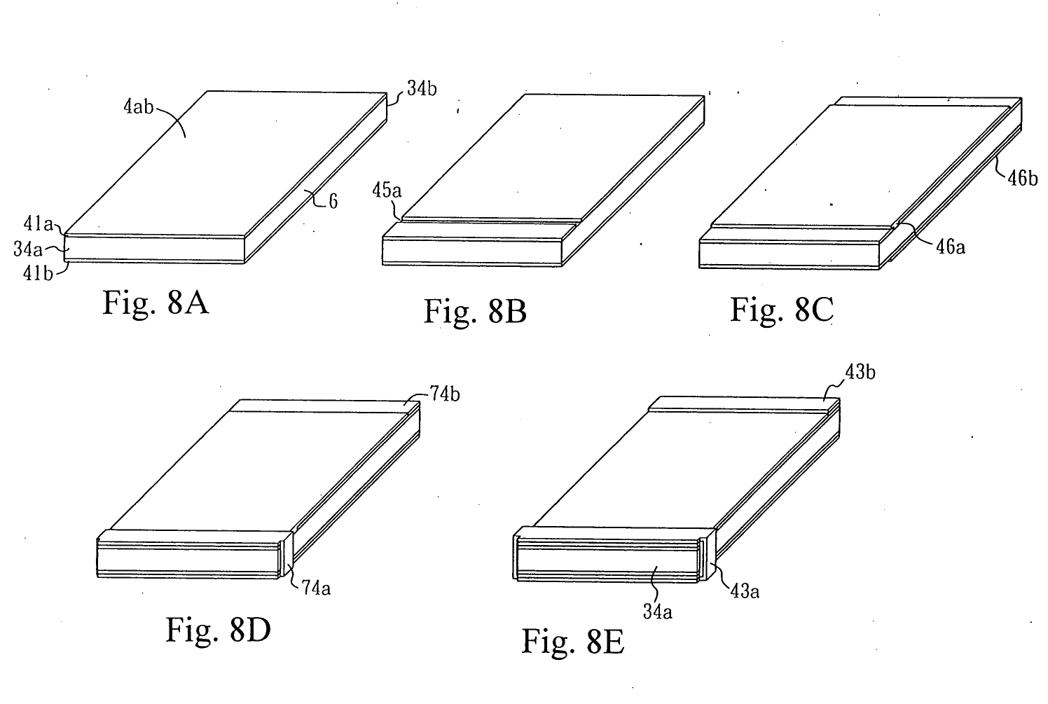

FIGS. 8A-8E illustrate a second method of manufacturing the electrode connection structure of resetable over-current protection device shown in FIGS. 4A-4E. Differing from the device component 4ab of FIGS. 7A-7E, the device component 4ab in FIGS. 8A-8E is provided with the looped first left connection layer 74a and second left connection layer 43a proximate to one end face 34a of the component, and only the top laminar electrode 41a proximate to another end face 34b of the component 4ab is covered with the first right connection 74b and second right connection 43b, without the provision of the bottom trench 46b.

The above embodiments for the electrode connection structure disclose a two-layer electrode structure, while modifications may be made to obtain a structure having more than two layers.

The following effects may be easily observed from the embodiments for the resetable over-current protection devices illustrated in FIGS. 3A-3E to FIGS. 8A-8E according to the present invention:

1. The waste of material is reduced to a minimum because it is not necessary to drill circular through holes or elongated through slots into the primary sheet to ensure full utilization of the primary sheet.

2. The area occupied by the electrode connections is minimized to provide a maximum area for expansion of the polymer material, such that lowering of strength requirements for the electrode structure becomes possible.

3. The electrode connections of each component unit are designed to dodge away from the end faces formed by the incision lines, to allow easy operation, to reduce resource consumption, and to ensure that subsequent manufacturing processes do not cause damages to the electrode connection structure.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. A resetable over-current protection device, comprising:
a resistance variable material, having: a top surface, a bottom surface, a left end face, and a right end face;
a top laminar electrode disposed on the top surface, the top laminar electrode having a top trench for exposing a part of the material;
a bottom laminar electrode disposed on the bottom surface;
a top insulation layer covering a part of the top laminar electrode and the top trench;
a bottom insulation layer covering a part of the bottom laminar electrode;
a first left connection layer, covering a part of the left end face of the material, and the top laminar electrode and bottom laminar electrode proximate to the left end face, for electrically connecting the top laminar electrode and the bottom laminar electrode;
a first right connection, covering the top laminar electrode proximate to the right end face;
a second left connection layer, covering the first left connection layer to serve as a first contact point; and
a second right connection, covering the first right connection to serve as a second contact point.

2. The device according to claim 1, wherein the first left connection layer covers 15 to 95% of an entire area of the left end face of the material.

3. The device according to claim 1, wherein the first left connection layer covers 30 to 80% of an entire area of the left end face of the material.

4. The device according to claim 1, wherein the first left connection layer covers 35 to 50% of an entire area of the left end face of the material.

5. A method for manufacturing the resetable over-current protection devices of claim 1, comprising the steps of:
(a) providing a resistance variable sheet having a top laminar electrode and a bottom laminar electrode;
(b) cutting the sheet into a plurality of strips, each strip having: a top surface, a bottom surface, a left end face and a right end face;
(c) removing a part of the top laminar electrode of each of the strips along a longitudinal direction of the sheet to form a top trench, for exposing a part of the sheet;
(d) covering a part of the top laminar electrode and the top trench with a top insulation layer;
(e) covering a part of the bottom laminar electrode with a bottom insulation layer;
(f) covering each of the top laminar electrode and the bottom laminar electrode proximate to the left end face, and a part of the left end of each of the strips with first left connection layers, for electrically connecting the top laminar electrode and the bottom laminar electrode;
(g) covering the top laminar electrode proximate to the right end face with a first right connection;
(h) covering each of the first left connection layers with second left connection layers serving as a first contact point;
(i) covering the first right connection with a second right connection serving as a second contact point; and
(j) cutting each of the strips to form a plurality of resetable over-current protection devices.

6. A resetable over-current protection device, comprising:
a resistance variable material, having: a top surface, a bottom surface, a left end face and a right end face;
a top laminar electrode disposed on the top surface, the top laminar electrode having a top trench for exposing a part of the material;
a bottom laminar electrode disposed on the bottom surface, the bottom laminar electrode having a bottom trench for exposing a part of the material;
a top insulation layer covering a part of the top laminar electrode and the top trench;
a bottom insulation layer covering a part of the bottom laminar electrode and the bottom trench;
a first left connection layer, covering a part of the left end face of the material, and the top laminar electrode and bottom laminar electrode proximate to the left end face, for electrically connecting the top laminar electrode and the bottom laminar electrode;
a first right connection, covering a part of the right end face of the material, and the top laminar electrode and bottom laminar electrode proximate to the right end face, for electrically connecting the top laminar electrode and the bottom laminar electrode;
a second left connection layer, covering the first left connection layer to serve as a first contact point; and
a second right connection, covering the first right connection to serve as a second contact point.

7. The device according to claim 6, wherein the first left connection layer covers 15 to 95% of an entire area of the left end face of the material and the first right connection layer covers 15 to 95% of an entire area of the right end face of the material.

8. The device according to claim 6, wherein the first left connection layer covers 30 to 80% of an entire area of the left end face of the material and the first right connection layer covers 30 to 80% of an entire area of the right end face of the material.

9. The device according to claim 6, wherein the first left connection layer covers 35 to 50% of an entire area of the left end face of the material and the first right connection layer covers 35 to 50% of an entire area of the right end face of the material.

10. A method for manufacturing the resetable over-current protection devices of claim 6, comprising the steps of:
(a) providing a resistance variable sheet having a top laminar electrode and a bottom laminar electrode;
(b) cutting the sheet into a plurality of strips, each strip having: a top surface, a bottom surface, a left end face and a right end face;
(c) removing a part of the top laminar electrode of each of the strips along a longitudinal direction of the sheet to form a top trench, for exposing a part of the sheet;
(d) removing a part of the bottom laminar electrode of each of the strips along a longitudinal direction of the sheet to form a bottom trench, for exposing a part of the sheet;
(e) covering a part of the top laminar electrode and the top trench with a top insulation layer;
(f) covering a part of the bottom laminar electrode with a bottom insulation layer and the bottom trench;
(g) covering each of the top laminar electrode and the bottom laminar electrode proximate to the left end face, and a part of the left end of each of the strips with first left connection layers, for electrically connecting the top laminar electrode and the bottom laminar electrode;
(h) covering each of the top laminar electrode and the bottom laminar electrode proximate to the right end face, and a part of the right end of each of the strips with first right connection layers, for electrically connecting the top laminar electrode and the bottom laminar electrode;
(i) covering each of the first left connection layers with second left connection layers serving as a first contact point;
(j) covering each of the first right connections with second right connections serving as a second contact point; and
(k) cutting each of the strips to form a plurality of resetable over-current protection devices.

11. A resetable over-current protection device, comprising:
a resistance variable material, having: a top surface, a bottom surface, a left end face, and a right end face;
a top laminar electrode disposed on the top surface, the top laminar electrode having a top trench for exposing a part of the material;
a bottom laminar electrode disposed on the bottom surface;
a top insulation layer covering a part of the top laminar electrode and the top trench;
a bottom insulation layer covering a part of the bottom laminar electrode;
a first left connection layer, covering the top laminar electrode and the bottom laminar electrode proximate to the left end face, and the material proximate to the left end face and the right end face, for electrically connecting the top laminar electrode and the bottom laminar electrode;
a first right connection, covering the top laminar electrode proximate to the right end face;
a second left connection layer, covering the first left connection layer to serve as a first contact point; and
a second right connection, covering the first right connection to serve as a second contact point.

12. A method for manufacturing the resetable over-current protection devices of claim 11, comprising the steps of:
(a) providing a resistance variable sheet having a top laminar electrode and a bottom laminar electrode;
(b) cutting the sheet into a plurality of strips, each strip having: a top surface, a bottom surface, a left end face and a right end face;
(c) removing a part of the top laminar electrode of each of the strips along a transverse direction of the sheet to form a plurality of top trenches, for exposing parts of the sheet;
(d) covering a part of the top laminar electrode and the top trench with a top insulation layer;
(e) covering a part of the bottom laminar electrode with a bottom insulation layer;
(f) covering each of the top laminar electrode, the bottom laminar electrode, the left end face and the right end face with first left connection layers to form a plurality of looped connection layers, for electrically connecting the top laminar electrode and the bottom laminar electrode;
(g) covering each of the first left connection layers with second left connection layers serving as a contact point; and
(j) cutting each of the strips to form a plurality of resetable over-current protection devices.

13. A resetable over-current protection device, comprising:
a resistance variable material, having: a top surface, a bottom surface, a left end face, and a right end face;
a top laminar electrode disposed above the top surface, the top laminar electrode having a top trench for exposing a part of the material;
a bottom laminar electrode disposed above the bottom surface, the bottom laminar electrode having a bottom trench for exposing a part of the material;
a top insulation layer covering a part of the top laminar electrode and the top trench;
a bottom insulation layer covering a part of the bottom laminar electrode and the bottom trench;
a first left connection layer, covering the top laminar electrode and the bottom laminar electrode proximate to the left end face, and the material proximate to the left end face and the right end face, for electrically connecting the top laminar electrode and the bottom laminar electrode;
a first right connection layer, covering the top laminar electrode and the bottom laminar electrode proximate to the right end face, and the material proximate to the left end face and the right end face, for electrically connecting the top laminar electrode and the bottom laminar electrode;
a second left connection layer, covering the first left connection layer to serve as a first contact point; and
a second right connection, covering the first right connection to serve as a second contact point.

14. A method for manufacturing resetable over-current protection devices of claim 13, comprising the steps of:
(a) providing a resistance variable sheet having a top laminar electrode and a bottom laminar electrode;
(b) cutting the sheet into a plurality of strips, each strip having: a top surface, a bottom surface, a left end face and a right end face;
(c) removing a part of the top laminar electrode of each of the strips along a transverse direction of the sheet to form a plurality of top trenches, for exposing parts of the sheet;
(d) removing a part of the bottom laminar electrode of each of the strips along a transverse direction of the sheet to form a plurality of bottom trenches, for exposing parts of the sheet;
(e) covering a part of the top laminar electrode and the top trench with a top insulation layer;
(f) covering a part of the bottom laminar electrode with a bottom insulation layer and the bottom trenches;
(g) covering each of the top laminar electrode, the bottom laminar electrode, the left end face and the right end face with first left connection layers to form a plurality of looped connection layers, for electrically connecting the top laminar electrode and the bottom laminar electrode;
(h) covering each of the top laminar electrode, the bottom laminar electrode, the left end face and the right end face of each of the strips with first right connection layers, whereby each of the first right connections electrically connects the top laminar electrode and the bottom laminar electrode;
(i) covering each of the first left connection layers with second left connection layers serving as a first contact point;
j) covering each of the first right connections with second right connections serving as a second contact point; and
(k) cutting each of the strips to form a plurality of resetable over-current protection devices.
